(19) United States
(12) Patent Application Publication
(10) Pub. No.: US 2017/0364484 A1
(43) Pub. Date: Dec. 21, 2017

(54) ENHANCED TEXT METADATA SYSTEM AND METHODS FOR USING THE SAME

(71) Applicant: Peter Hayes, Clearwater, FL (US)

(72) Inventor: Peter Hayes, Clearwater, FL (US)

(73) Assignee: VTCSecure LLC, Clearwater, FL (US)

(21) Appl. No.: 15/629,338

(22) Filed: Jun. 21, 2017

Related U.S. Application Data
(60) Provisional application No. 62/352,807, filed on Jun. 21, 2016.

(51) Int. Cl. G06F 17/21; G10L 15/26; G06F 17/27; G06K 9/00; G10L 25/90; G10L 25/63

(52) U.S. Cl. CPC G06F 17/214; G10L 25/90; G10L 25/63; G06F 17/276; G06K 9/00302; G10L 15/26

(57) ABSTRACT

Apparatuses and methods for enhanced text metadata systems are described herein. In a non-limiting embodiment, a camera on an electronic device may be activated in response to receiving a signal indicating a message is being inputted by a user. While receiving the message, a camera may capture an image of the user. This image may be analyzed to determine an emotion the user is feeling when inputting the message. Once an emotion of the user is determined, the message will be altered to reflect the emotion the user is feeling.

### CROSS REFERENCE TO RELATED APPLICATION

This application claims the benefit of U.S. Provisional Application No. 62/352,807 filed on Jun. 21, 2016, the disclosure of which is incorporated herein by reference in its entirety.

### BACKGROUND

This disclosure generally relates to enhanced text metadata systems and methods for using the same. Text input systems today lack the ability to easily and accurately convey the full meaning that the writer wishes to express. While punctuation and word choice can be used in an attempt to visually illustrate in written text the general feeling of a writer, even in combination punctuation and word choice do not come close to replicating the nuance that is conveyed when a person is able to see the writer's facial expression or hear them speak what they are writing. These facial expressions and vocal variations convey a whole host of feelings, emotion, emphasis, tone, tenor, and mood that enhance the meaning of the spoken or written words. Accordingly, it is the objective of the present disclosure to provide enhanced text metadata systems, and methods for using the same.

### BRIEF DESCRIPTION OF THE DRAWINGS

FIG. 1A is an illustrative diagram of an exemplary electronic device receiving a message, in accordance with various embodiments;

FIG. 1B is an illustrative diagram of an exemplary image of the user from FIG. 1A, in accordance with various embodiments;

FIG. 1C is an illustrative diagram showing the message from FIG. 1A being alerted to reflect the emotions of the user depicted in FIG. 1B, in accordance with various embodiments;

FIG. 2 is an illustrative diagram of an exemplary electronic device in accordance with various embodiments;

FIG. 3 is an illustrative diagram of exemplary alterations to a message in accordance with various embodiments;

FIG. 4 is an illustrative flowchart of an exemplary process in accordance with various embodiments; and

FIG. 5 is an illustrative flowchart of an exemplary process in accordance with various embodiments.

### DETAILED DESCRIPTION

The present invention may take form in various components and arrangements of components, and in various techniques, methods, or procedures and arrangements of steps. The referenced drawings are only for the purpose of illustrated embodiments, and are not to be construed as limiting the present invention. Various inventive features are described below that can each be used independently of one another or in combination with other features.

In one exemplary embodiment, a method for facilitating the enhancement of text inputs to show feeling, emotion, emphasis, tone, tenor and mood is provided. In some embodiments an electronic device may determine that a first user operating a first electronic device is inputting text for communication, for example a real-time text (“RTT”), simple message system text (“SMS”), or electronic mail (“email”), with a second user operating a second electronic device. In response to determining a first user is inputting text for communication, input circuitry of the electronic device may send a signal that activates a camera of the electronic device. The electronic device activates a camera on the first electronic device that is able to see the first user's face. In some embodiments, the camera may capture a first image of the first user's face. This image may be analyzed by comparing the image to a plurality of predefined facial expressions and determining that a predefined facial expression is associated with the first user's face. The electronic device, may then determine an emotion that is associated with the predefined facial expression. Based on the determined emotion, the electronic device may alter the inputted text to reflect the emotion of the first user. For example, if the user is happy, the electronic device may input a ‘smiley emoji’ at the end of the inputted text.

In some embodiments, the camera on the electronic device captures the facial expression of the first user as the first user types the RTT, SMS or email. The electronic device then processes the captured image of the first user's face or to assess the facial features of the first user and translate those facial features into a small digital image or icon (“emoji”) and then insert the picture or emoji into the RTT or SMS text stream after each sentence or phrase to convey the tone or mood of the first user as they type. The picture or emoji may be different for each sentence or phrase depending on the tone or mood of the first user. The enhanced text is then transmitted to the second user and displayed on the second electronic device. The process may be repeated on the second electronic device to convey the feeling, emotion, emphasis, tone, tenor and mood of the second user in the text transmitted to the first user.

In another exemplary embodiment a second method for facilitating the enhancement of text inputs to show feeling, emotion, emphasis, tone, tenor and mood is provided. In some embodiments an electronic device may determine that a first user operating a first electronic device is inputting text for communication, for example a RTT, SMS or email, with a second user operating a second electronic device. In response to determining a first user is inputting text for communication, input circuitry of the electronic device may send a signal that activates a camera of the electronic device. The electronic device activates a camera on the first electronic device that is able to see the first user's face. The camera on the first electronic device captures the facial expression of the first user as the first user types the RTT, SMS message or email. The electronic device then uses software processes to assess the facial features of the first user and translate those facial features into enhancements to the text data. The enhancements may include changes to the font, font size, or color of the text; changes to the capitalization or spacing between letters or words; insertion of punctuation marks; or addition of emoji to the text to convey the tone or mood of the first user as they type. The enhanced text is then transmitted to the second user and displayed on the second electronic device. The process may be repeated on the second electronic device to convey the feeling, emotion, emphasis, tone, tenor and mood of the second user in the text transmitted to the first user.

In a third exemplary embodiment, a method for facilitating the enhancement of speech-to-text (“STT”) to show feeling, emotion, emphasis, tone, tenor and mood is provided. In some embodiments an electronic device may determine that a first user operating a first electronic device has initiated a STT communication with a second user operating a second electronic device. The electronic device activates a camera in the first electronic device. Audio data representing the speech of the first user may then be received at the electronic device. The audio data or a duplicate of the audio data may then be sent to a remote automated STT device. Text data may then be generated that may represent the audio data or duplicated version of the audio data using STT functionality. The text data may be sent back to the electronic device where the electronic device may use software processes to assess the facial features of the first user or the volume, cadence or other characteristics of the first user's speech. The electronic device may then translate those facial features or speech characteristics into enhancements to the text data. The enhancements may include changes to the font, font size, color or other attributes of the text (for example bold, underline, italics, strikethrough, superscript or subscript); changes to the capitalization or spacing between letters or words; insertion of punctuation marks; or addition of emoji or artwork to the text. The enhanced text is then transmitted to the second user, with or without the accompanying audio data, and displayed on the second electronic device. The process may be repeated on the second electronic device to convey the feeling, emotion, emphasis, tone, tenor and mood of the second user in the text transmitted to the first user.

In a fourth exemplary embodiment, a method for facilitating the generation or enhancement of closed captioning for video programming to show feeling, emotion, emphasis, tone, tenor and mood is provided. In some embodiments an electronic device may determine that audio or video data is being transmitted through it to one or more other devices. The audio data or the audio portion of any video data may then be sent to a remote automated STT device. Text data may then be generated that may represent the audio data using STT functionality. The text data may be sent back to the electronic device where the electronic device may use software processes to assess facial features or other visual elements in the video data or the volume, cadence or other characteristics of the audio data. The electronic device may then translate those characteristics into enhancements to the text data. The enhancements may include changes to the font, font size, color or other attributes of the text (for example bold, underline, italics, strikethrough, superscript or subscript); changes to the capitalization or spacing between letters or words; insertion of punctuation marks; or addition of emoji or artwork to the text. The enhanced text is then transmitted to the other device or devices for display as closed captioning that conveys feeling, emotion, emphasis, tone, tenor and mood.

In a fifth exemplary embodiment, a method for facilitating the generation or enhancement of text inputs to show feeling, emotion, emphasis, tone, tenor and mood is provided. In some embodiments an electronic device may determine that text is being input. The electronic device activates a camera that is able to see the user's face. The camera on the electronic device captures the facial expression of the user as the user types. The electronic device may use software processes to assess facial features of the user. The electronic device may then translate those facial features into enhancements to the text data. The enhancements may include changes to the font, font size, color or other attributes of the text (for example bold, underline, italics, strikethrough, superscript or subscript); changes to the capitalization or spacing between letters or words; insertion of punctuation marks; or addition of emoji or artwork to the text. The enhanced text is then displayed to the user or stored on the electronic device.

As used herein, emotion can mean any feeling, reaction, or thought, including, but not limited to, joy, anger, surprise, fear, contempt, sadness, disgust, alert, excited, happy, pleasant, content, serene, relax, calm, fatigued, bored, depressed, upset, distressed, nervous, anxious and tense. The aforementioned list is merely exemplary, and any emotion may be used.

As used herein, letters, words, or sentences may be any string of characters. Moreover, letters, words, or sentences include letters, words, or sentences from any language.

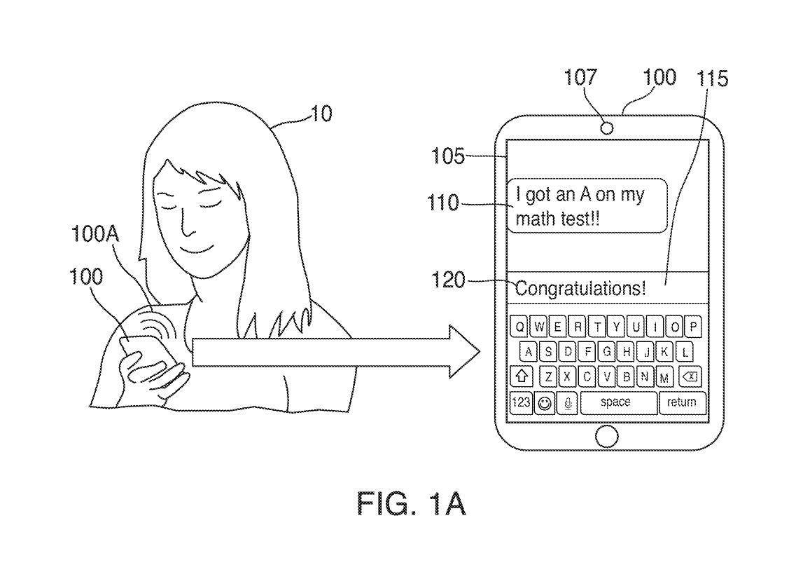

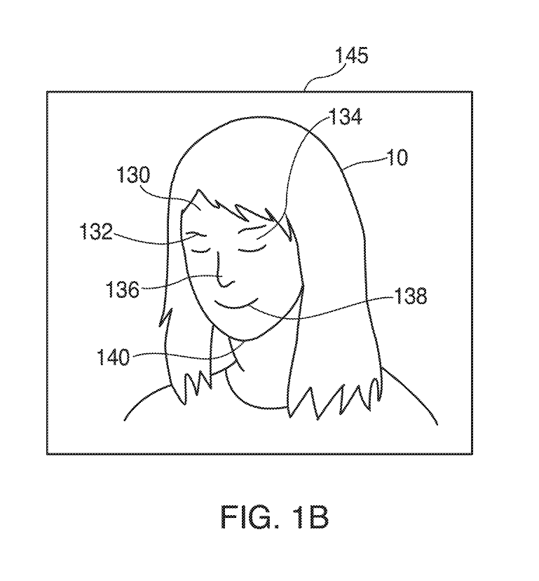

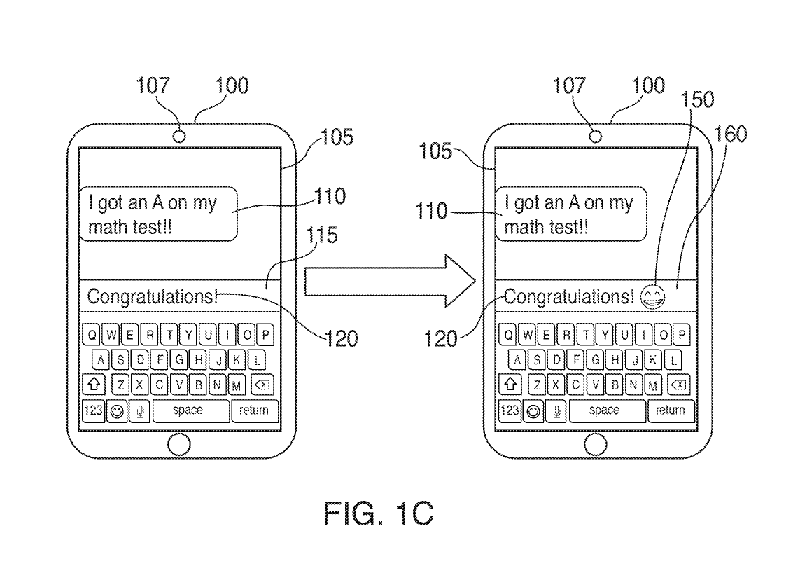

FIG. 1A is an illustrative diagram of exemplary electronic device 100 receiving a message, in accordance with various embodiments. Electronic device 100 may correspond to any suitable type of electronic device including, but are not limited to, desktop computers, mobile computers (e.g., laptops, ultrabooks), mobile phones, smart phones, tablets, televisions, set top boxes, smart televisions, personal display devices, personal digital assistants (“PDAs”), gaming consoles, and/or wearable devices (e.g., watches, pins/broaches, headphones, etc). In some embodiments, electronic device 100 may include one or more components for receiving mechanical inputs or touch inputs, such as a touch screen and/or one or more buttons. Electronic device 100, in some embodiments, may correspond to a network of devices.

In the non-limiting embodiment, electronic device 100 may include camera 107 and display screen 105. Camera 107 may be any device that can record visual images in the form of photographs, film, or video signals. In one exemplary, non-limiting embodiment, camera 107 is a digital camera that encodes digital images and videos digitally and stores them on local or cloud-based memory. Camera 107 may, in some embodiments, be configured to capture photographs, sequences of photographs, rapid shots (e.g., multiple photographs captured sequentially during a relatively small temporal duration), videos, or any other type of image, or any combination thereof. In some embodiments, electronic device 100 may include multiple camera 107, such as one or more front-facing cameras and/or one or more rear facing cameras. Furthermore, camera 107 may be configured to recognize far-field imagery (e.g., objects located at a large distance away from electronic device 100) or near-filed imagery (e.g., objected located at a relatively small distance from electronic device 100). In some embodiments, camera 107 may be high-definition (“HD”) cameras, capable of obtaining images and/or videos at a substantially large resolution (e.g., 726p, 1080p, 1080i, etc.). In some embodiments, camera 107 may be optional for electronic device 100. For instance, camera 107 may be external to, and in communication with, electronic device 100. For example, an external camera may be capable of capturing images and/or video, which may then be provided to electronic device 100 for viewing and/or processing. In some embodiments, camera 107 may be multiple cameras.

Display screen 105 may be any device that can output data in a visual form. Various types of displays may include, but are not limited to, liquid crystal displays (“LCD”), monochrome displays, color graphics adapter (“CGA”) displays, enhanced graphics adapter (“EGA”) displays, variable graphics array (“VGA”) display, or any other type of display, or any combination thereof. Various types of displays may include, but are not limited to, liquid crystal displays (“LCD”), monochrome displays, color graphics adapter (“CGA”) displays, enhanced graphics adapter (“EGA”) displays, variable graphics array (“VGA”) display, or any other type of display, or any combination thereof. Still further, a touch screen may, in some embodiments, correspond to a display device including capacitive sensing panels capable of recognizing touch inputs thereon. For instance, display screen 105 may correspond to a projected capacitive touch (“PCT”), screen include one or more row traces and/or driving line traces, as well as one or more column traces and/or sensing lines. In some embodiments, display screen 105 may be an optional component for electronic device 100. For instance, electronic device 100 may not include display screen 105. Such devices, sometimes referred to as “headless” devices, may output audio, or may be in communication with a display device for outputting viewable content.

In some embodiments, display screen 105 may correspond to a high-definition (“HD”) display. For example, display screen 105 may display images and/or videos of 720p, 1080p, 1080i, or any other image resolution. In these particular scenarios, display screen 105 may include a pixel array configured to display images of one or more resolutions. For instance, a 720p display may present a 1024 by 768, 1280 by 720, or 1366 by 768 image having 786,432; 921,600; or 1,049,088 pixels, respectively. Furthermore, a 1080p or 1080i display may present a 1920 pixel by 1080 pixel image having 2,073,600 pixels. However, the aforementioned display ratios and pixel numbers are merely exemplary, and any suitable display resolution or pixel number may be employed for display screen 105, such as non-HD displays, 4K displays, and/or ultra displays.

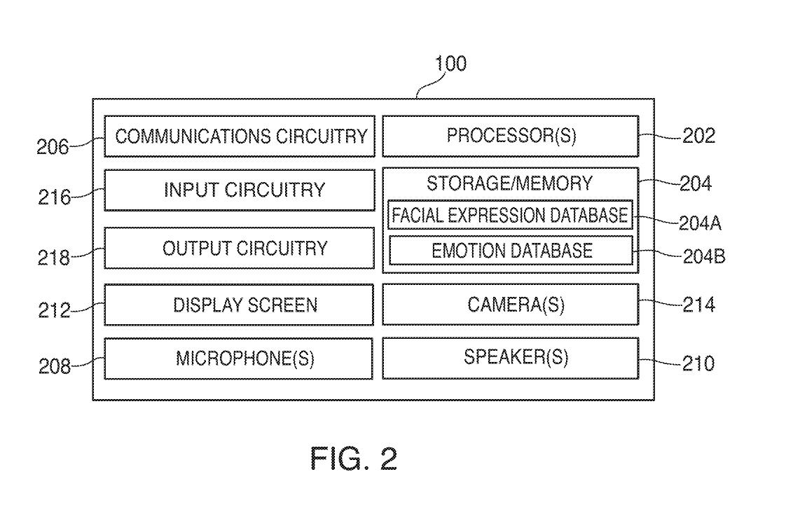

In some embodiments, first user 10 may receive incoming message 110 from a second user. For example, first user 10 may receive an incoming message that states “I got an A on my math test!!” Incoming message 110 may be any form of electronic message, including, but not limited to RTT, SMS, email, instant message, video chat, audio chat, or voicemail. This list is merely exemplary and any electronic message may be incoming message 110. In some embodiments, incoming message 110 may be displayed on display screen 105 of electronic device 100. However, in some embodiments, incoming message 110 may be in audio form. In this embodiment, instead of incoming message 110 being displayed on display screen 105, speakers of electronic device 100 may output an audio file that states “I got an A on my math test!!” In some embodiments, the audio file may be the second user speaking. In other embodiments, text received by electronic device 100 may be converted into audio using text-to-speech functionalities of electronic device 100. Speakers of electronic device 100 are described in more detail below in connection with speaker(s) 210 of FIG. 2, and the same description applies herein. In some embodiments, incoming message 110 may be a video message from the second user. This video message may be a prerecorded video message or a live streaming video message.

Once incoming message is received, first user 10 may begin to prepare a response. For example, in response to receiving the message “I got an A on my math test!!” first user 10 may prepare outgoing message 115 that includes text 120 stating “Congratulations!” Outgoing message 115 may be an electronic message similar to incoming message 110 and the same description applies herein. In some embodiments, when first user 10 prepares outgoing message 115, camera 107 may capture 100A an image of first user 10. The image captured by camera 107, may depict first user 10's emotion while entering text 120 of outgoing message 115. In some embodiments, camera 107 may capture 100A an image after first user 10 has inputted text 120. Capture 100A may refer to any method or means of a camera taking a photo or video. For example, camera 107 may capture 100A an image after first user 10 has typed “Congratulations!” In some embodiments, camera 107 may capture 100A an image before first user 10 has inputted text 120. For example, camera 107 may capture 100A an image before first user 10 has typed “Congratulations!” Moreover, in some embodiments, camera 107 may capture 100A multiple images of first user 10. For example, camera 107 may capture 100A three images, one image as first user 10 begins to type a message, one image as first user 10 is typing the message, and one image after first user 10 has typed the message. This embodiment of three images is merely exemplary, and camera 107 may capture 100A any number of images.

In some embodiments, first user 10 may not receive incoming message 110 from a second user. In these embodiments, camera 107 may capture 100A an image of first user 10 in response to first user 10 creating outgoing message 115.

FIG. 1B is an illustrative diagram of an exemplary image of the user from FIG. 1A, in accordance with various embodiments. In some embodiments, camera 107 may capture 100A image 145 of first user 10's face 130. While image 145 captures the entire face of first user 10 in FIG. 1B, image 145, in some embodiments, may be only a portion of first user 10's face. Face 130 may be any head of any human. In some embodiments, face 130 may not be the face of the user inputting a message on electronic device 100. For example, first user 10 may be typing a message for a third user. Electronic device 100, in those embodiments, may capture 100A image 145 of a third user.

In some embodiments, face 130 may include eyebrow(s) 132, eye(s) 134, nose 136, mouth 138, and chin 140. In some embodiments one or more parts of face 130 may be omitted. For example, image 145 may not include the entire face of first user 10. Additionally, first user 10 may not have eyebrow(s) 132. Moreover, in some embodiments, additional parts of face 130 may be included. For example, face 130 may include the ears of first user 10. Electronic device 100 may analyze face 130 to determine the emotion of first user 10. In some embodiments, electronic device may analyze face 130 by examining emotional channels that may indicate the emotion of first user 10. Emotional channels may refer to facial features that indicate the emotion of a person. Emotional channels may include, but are not limited to, a smile, eyebrow furrow, eyebrow raise, lip corner depressor (i.e. a frown), inner eyebrow raise, eye closure, nose wrinkle, upper lip raise, lip suck, lip pucker, lip press, mouth open, chin raise, and smirk. This list is not exhaustive and any facial feature that can indicate the emotion of a person may be used.

In some embodiments, electronic device 100 may analyze face 130 to determine the head orientation of first user 10. For example, electronic device 100 may determine if first user 10's head is at an angle, tilted up, tilted down, or turned to the side. The aforementioned head orientations are merely exemplary and electronic device 100 may determine any pitch, yaw, or roll angles in 3D space to determine a possible emotion of first user 10. Moreover, in some embodiments, electronic device 100 may analyze face 130 to determine the intraocular distance of first user 10. For example, electronic device 100 may determine the distance between eye(s) 134 outer corners.

In some embodiments, as shown in FIG. 1B, mouth 138 is smirking, which can indicate happiness. Moreover, Eyebrow(s) 132 and nose 136 are relaxed, and eye(s) 134 are closed. These may indicate that first user 10 is calm. Chin 130 is shown level, which may indicate first user 10 is happy. Facial features may indicate a wide range of emotions. For example if eye(s) 134 are wide open, eyebrow(s) 132 are raised high, mouth 138 is open, chin 140 is lowered, first user 10 may be surprised. As another example, if eye(s) 134 are turned away, nose 136 is wrinkled, mouth 138 is closed, and chin 140 is jutting out, first user 10 may be disgusted. The above emotions determined by using emotional channels are merely exemplary for the purposes of illustrating a potential analysis of face 130.

In some embodiments, electronic device 100 may analyze face 130 by examining facial landmarks or features of face 130. This analysis may determine the relative positions of the eyes, nose, cheekbones, and jaw. Additionally, this analysis may determine the relative size of the eyes, nose, cheekbones, and jaw. Moreover, this analysis may determine the shape of the eyes, nose, cheekbones, and jaw. Once the relative positions, size, and/or shapes are determined, electronic device 100 may compare the collected data to a plurality of predefined facial expressions stored in a facial expression database. The facial expression database may be similar to facial expression database 204A described in connection with FIG. 2, and the same description applies herein. If there is a match, or a similar predefined facial expression, electronic device 100 may determine the emotion of first user 10.

While the above embodiments demonstrate a couple different methods of analyzing facial features, any analysis may be used to determine the emotion of first user 10.

FIG. 1C is an illustrative diagram showing the message from FIG. 1A being alerted to reflect the emotions of the user depicted in FIG. 1B, in accordance with various embodiments. In some embodiments, electronic device 100 may determine first user 10 is happy when typing text 120. For example, electronic device 100 may analyze face 130's emotional channels and determine that because mouth 138 is smirking, first user 10 is happy. After determining the emotion of first user 10, electronic device may alter outgoing message 115. Outgoing message 115 may be altered by electronic device 100 to reflect the determine emotion of first user 10. For example, electronic device 100 may generate second message 160. Second message 160, in some embodiments, may include text 120 and an alteration to outgoing message 115. In this example, because first user 10 has been determined to be happy, the alteration may be smiling emoji 150. Alterations of messages can include, but are not limited to changing the font type, font color, typographical emphasis, capitalization, spacing between letters or words, punctuation. Additionally, alternations, in some embodiments, may include emojis. Alterations, in some embodiments, may also include Graphics Interchange Format (“GIF”), both static and animated. In some embodiments, alterations may also include memes, photos, and videos. For example, a user may have an image that the user wants to be used in alterations when the user is angry. This image can be an angry photo the user. In this example, electronic device 100 may add the angry photo of the user when electronic device 100 determines that the user is angry when typing a message.

The alteration, in some embodiments, may be based on an emotion category. In those embodiments, emotions may be stored in categories. For example, every emotion may be put into three categories—positive, negative, and neutral. Positive may include happy, excited, and relieved. Negative may include angry, unhappy, and shame. Neutral may include focused, interested, and bored. In some embodiments, electronic device 100 may have alterations associated with each category. For example, positive emotions may cause electronic device 100 to alter outgoing message 115 by changing the font to a ‘bubbly happy font’ and adding a smiley emoji. Negative emotions may cause electronic device 100 to alter outgoing message 115 by making the font bold and changing the font color red. Neutral emotions may cause electronic device 100 to not alter outgoing message 115. Three categories for emotions are merely exemplary and any amount of categories may be used.

FIG. 2 is an illustrative diagram of an exemplary electronic device 100 in accordance with various embodiments. Electronic device 100, in some embodiments, may include processor(s) 202, storage/memory 204, communications circuitry 206, microphone(s) 208, speaker(s) 210 or other audio output devices, display screen 212, camera(s) 214, input circuitry 216, and output circuitry 218. One or more additional components may be included within electronic device 100 and/or one or more components may be omitted. For example, electronic device 100 may include one or more batteries or an analog-to-digital converter. Display screen 212 and camera(s) 214 may be similar to display screen 105 and camera 107 respectively, both described above in connection with FIG. 1A and those descriptions applying herein.

Processor(s) 202 may include any suitable processing circuitry capable of controlling operations and functionality of electronic device 100, as well as facilitating communications between various components within electronic device 100. In some embodiments, processor(s) 202 may include a central processing unit (“CPU”), a graphic processing unit (“GPU”), one or more microprocessors, a digital signal processor, or any other type of processor, or any combination thereof. In some embodiments, the functionality of processor(s) 202 may be performed by one or more hardware logic components including, but not limited to, field-programmable gate arrays (“FPGA”), application specific integrated circuits (“ASICs”), application-specific standard products (“AS SPs”), system-on-chip systems (“SOCs”), and/or complex programmable logic devices (“CPLDs”). Furthermore, each of processor(s) 202 may include its own local memory, which may store program systems, program data, and/or one or more operating systems. However, processor(s) 202 may run an operating system (“OS”) for electronic device 100, and/or one or more firmware applications, media applications, and/or applications resident thereon.

Storage/memory 204 may include one or more types of storage mediums such as any volatile or non-volatile memory, or any removable or non-removable memory implemented in any suitable manner to store data for electronic device 100. For example, information may be stored using computer-readable instructions, data structures, and/or program systems. Various types of storage/memory may include, but are not limited to, hard drives, solid state drives, flash memory, permanent memory (e.g., ROM), electronically erasable programmable read-only memory (“EEPROM”), CD-ROM, digital versatile disk (“DVD”) or other optical storage medium, magnetic cassettes, magnetic tape, magnetic disk storage or other magnetic storage devices, RAID storage systems, or any other storage type, or any combination thereof. Furthermore, storage/memory 204 may be implemented as computer-readable storage media (“CRSM”), which may be any available physical media accessible by processor(s) 202 to execute one or more instructions stored within storage/memory 204. In some embodiments, one or more applications (e.g., gaming, music, video, calendars, lists, etc.) may be run by processor(s) 202, and may be stored in memory 204.

In some embodiments, storage/memory 204 may include facial expression database 204A and emotion database 204B. Facial expression database 204A may include predefined facial expressions that can be used to determine the emotion of a user. In some embodiments, a predefined facial expression is a feature of a face that can assist electronic device 100 in determining the emotion of a user. In some embodiments, facial expression database 204A and/or emotion database 204B may be a remote database(s). A predefined facial expression may, in some embodiments, include facial landmarks and features, emotional channels, head orientations, and interocular distance. This list is merely exemplary and any feature of a face may be used as a predefined facial expression.

In some embodiments, facial expression database 204A may include a plurality of combinations of facial landmarks and features. In this example, facial expression database 204A may include different positions, sizes, and/or shapes of the eyes, nose, cheekbones, and jaw. In some embodiments, each predefined facial expression may have metadata stored with it. The metadata may point to an emotion stored in emotion database 204B. For example, each position, size and/or shape may be associated with an emotion stored in emotion database 204B.

In some embodiments, facial expression database 204A may also include emotional channels that indicate the emotion of a user. For example, facial expression database 204A may include a smile, eyebrow furrow, eyebrow raise, lip corner depressor (i.e. a frown), inner eyebrow raise, eye closure, nose wrinkle, upper lip raise, lip suck, lip pucker, lip press, mouth open, chin raise, and smirk. This list is not exhaustive and any facial feature that can indicate the emotion of a person may be used. Each emotional channel, in some embodiments, may include metadata that may point to an emotion stored in emotion database 204B. For example, a smile in facial expression database 204A may be associated with happy in emotion database 204B. In some embodiments, facial expression database may also include head orientations and interocular distance.

Emotion database 204 may include a list of emotions that electronic device 100 may determine the user is feeling. In some embodiments, emotions may be stored in categories. For example, every emotion may be put into three categories-positive, negative, and neutral. Positive may include happy, desire, and relieved. Negative may include disgust, fear, and anger. Neutral may include focused, interested, and bored. As noted above, the three categories for emotions are merely exemplary and any amount of categories may be used.

Communications circuitry 206 may include any circuitry allowing or enabling one or more components of electronic device 100 to communicate with one another, and/or with one or more additional devices, servers, and/or systems. For example, communications circuitry 206 may facilitate communications between electronic device 100 and a second electronic device operated by a second user. Electronic device 100 may use various communication protocols, including cellular networks (e.g., GSM, AMPS, GPRS, CDMA, EV-DO, EDGE, 3GSM, DECT, IS-136/TDMA, iDen, LTE or any other suitable cellular network protocol), Transfer Control Protocol and Internet Protocol (“TCP/IP”) (e.g., any of the protocols used in each of the TCP/IP layers), Hypertext Transfer Protocol (“HTTP”), WebRTC, SIP, and wireless application protocol (“WAP”), Wi-Fi (e.g., 802.11 protocol), Bluetooth, radio frequency systems (e.g., 900 MHz, 1.4 GHz, and 5.6 GHz communication systems), infrared, BitTorrent, FTP, RTP, RTSP, SSH, and/or VOIP.

Communications circuitry 206 may use any communications protocol, such as any of the previously mentioned exemplary communications protocols. In some embodiments, electronic device 100 may include one or more antennas to facilitate wireless communications with a network using various wireless technologies (e.g., Wi-Fi, Bluetooth, radiofrequency, etc.). In yet another embodiment, electronic device 100 may include one or more universal serial bus (“USB”) ports, one or more Ethernet or broadband ports, and/or any other type of hardwire access port so that communications circuitry 206 allows electronic device 100 to communicate with one or more communications networks.

Microphone(s) 208 may be any component capable of detecting audio signals. For example, microphone 214 may include one more sensors or transducers for generating electrical signals and circuitry capable of processing the generated electrical signals. In some embodiments, user device may include one or more instances of microphone 214 such as a first microphone and a second microphone. In some embodiments, electronic device 100 may include multiple microphones capable of detecting various frequency levels (e.g., high-frequency microphone, low-frequency microphone, etc.). In some embodiments, electronic device 100 may include one or external microphones connected thereto and used in conjunction with, or instead of, microphone(s) 208.

Speaker(s) 210 may correspond to any suitable mechanism for outputting audio signals. For example, speaker(s) 210 may include one or more speaker units, transducers, or array of speakers and/or transducers capable of broadcasting audio signals and audio content to a room where electronic device 100 may be located. In some embodiments, speaker(s) 210 may correspond to headphones or ear buds capable of broadcasting audio directly to a user.

Input circuitry 216 may include any suitable mechanism and/or component for receiving inputs from a user operating electronic device 100. In some embodiments, input circuitry 216 may operate through the use of a touch screen of display screen 212. For example, input circuitry 216 may operate through the use of a multi-touch panel coupled to processor(s) 202, and may include one or more capacitive sensing panels. In some embodiments, input circuitry 216 may also correspond to a component or portion of output circuitry 218 which also may be connected to a touch sensitive display screen. For example, in response to detecting certain touch inputs, input circuitry 216 and processor(s) 202 may execute one or more functions for electronic device 100 and/or may display certain content on display screen 212 using output circuitry 218.

Output circuitry 218 may include any suitable mechanism or component for generating outputs for electronic device 100. Output circuitry 218 may operate a display screen that may be any size or shape, and may be located on one or more regions/sides of electronic device 100. For example, output circuitry 218 may operate display screen 212, which may fully occupy a first side of electronic device 100.

In some embodiments, input circuitry 216 of electronic device 100 may receive text data. For example, a user may input the message “Awesome!” As the user begins to type “Awesome!” input circuitry 216, in some embodiments, may output one or more signals to camera(s) 214. The signal output by input circuitry 216 may be any signal capable of activating camera(s) 214. In response to receiving a signal from input circuitry 216, camera(s) 214 may activate (i.e. turn on). In some embodiments, once camera(s) 214 is active, processor(s) 202 may determine whether a face of a user is in the frame of camera(s) 214. If a face is in the frame, camera(s) 214 may capture an image of the face. The image may be captured before the user inputs the text, as the user inputs the text, or after the user inputs the text. In some embodiments, multiple images may be taken. For example, three images may be captured, a first image before the user inputs the text, a second image as the user inputs the text, and a third image after the user inputs the text.

If a face is not in the frame, in some embodiments, camera(s) 214 may not capture an image. In some embodiments, there may be camera(s) 214 on both sides of electronic device 100 (i.e. a front camera and a back camera). If the front camera is activated by input circuitry 216 and processor(s) 202 has determined that no face is in frame, in some embodiments, a second signal may be output to activate the back camera. Once active, processor(s) 202 may determine whether a face is in the frame of the back camera. If a face is in the frame, the back camera may capture an image of the face. If no face is in the frame, in some embodiments, the back camera may not capture an image.

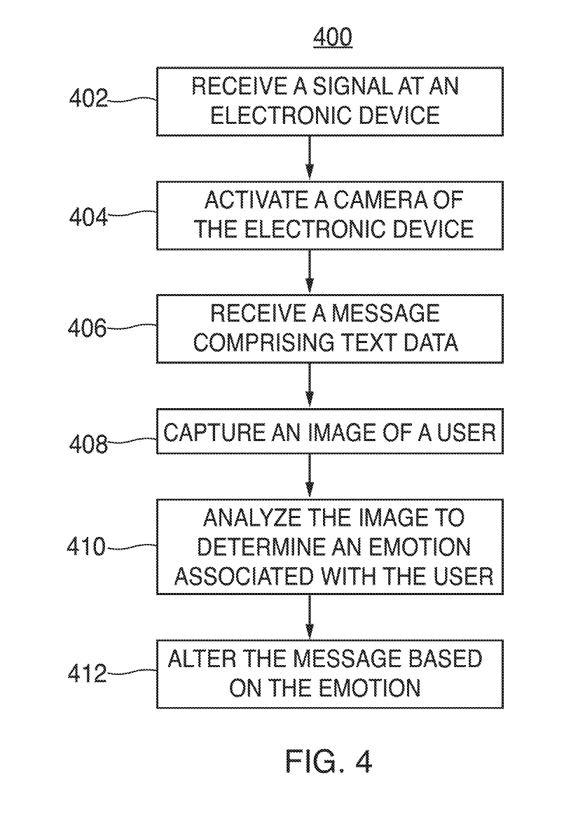

If a face has been captured in an image by camera(s) 214, processor(s) 202 may analyze the image. In some embodiments, processor(s) 202 may analyze by comparing the image to a plurality of predefined facial expressions. In some embodiments, processor(s) 202 may find a predefined facial expression stored in facial expression database 204A that can be associated with the face captured in the image. After finding a representative predefined facial expression, processor(s) 202 may determine an emotion associated with the predefined facial expression. For example, if a user is smiling when typing “Awesome!” processor 202 may analyze the captured image of the user smiling and determine the user is happy. A more detailed description of the analysis of a captured image, is located above in connection with FIG. 1B and below at step 410 in connection with FIG. 4, both descriptions applying herein. After determining an emotion associated with the user, processor(s) 202 may alter the message. For example, if the user is happy while typing “Awesome!” processor(s) 202 may add a happy emoji at the end of “Awesome!” Once the message has been altered, in some embodiments, communications circuitry 206 of electronic device 100 may transmit the altered message to a second electronic device.

In some embodiments multiple emotions can be determined by processor(s) 202. For example, if a user is typing multiple words, camera(s) 214 may capture multiple images of the user. Each image may be captured as each word is being typed. For example, if a user types the following message “I was so happy to see you today, but seeing you with your new girlfriend was not cool,” 18 photos may be captured for the 18 words. In this example, processor(s) 202 may determine that the user was happy during “I was so happy to see you today” and angry during “new girlfriend was not cool.” Processor(s), in some embodiments, may determine that the user was in a neutral mood during “seeing you with your.” Once an emotion or emotions of the user has been determined, processor(s) 202 may alter the message. For example “I was so happy to see you today” may be altered by changing the font to a ‘bubbly happy font.’ Additionally, “new girlfriend was not cool” may be altered by changing the font color to red, make the font bold, and adding extra spaces between “was,” “not,” and “cool.” The extra spaces, in some embodiments, may be presented as “was not cool,” in order to emphasize the emotion determined by processor(s) 202. Once the message has been altered, in some embodiments, communications circuitry 206 of electronic device 100 may transmit the altered message to a second electronic device.

In some embodiments, microphone(s) 208 of electronic device 100 may receive audio data from a user. For example, a user may want to send a message using their voice and state “Great.” In some embodiments, once microphone 208 starts to receive audio data from the user, camera(s) 214 may receive a signal activating camera(s) 214. In some embodiments, after microphone(s) 208 receives the first audio data, processor(s) 202 may analyze the first audio data to determine an emotion associated with the user. In some embodiments, processor(s) 202 may analyze the audio data based on the volume. For example, if a user shouts “Great!” processor(s) 202 may determine that the user is excited. In some embodiments, processor(s) 202 may analyze the audio data based on the pace of the audio data. For example, if a user slowly says “Great!” (i.e. “Greeeeaaaaat!”), processor(s) 202 may determine that the user is bored. In some embodiments, processor(s) 202 may determine the audio data based on the pitch and/or frequency of the audio data. For example, if a user says “Great!” in a high pitch, processor(s) 202 may determine that the user is annoyed. While only three types of analysis of audio are shown, any number of types of audio analysis may be conducted to determine the emotion of the user.

In some embodiments, if the camera is activated, processor(s) 202 may determine the emotion of a user by analyzing at least one image captured by camera(s) 214. If a face has been captured in an image by camera(s) 214, processor(s) 202 may analyze the image. In some embodiments, processor(s) 202 may analyze by comparing the image to a plurality of predefined facial expressions. In some embodiments, processor(s) 202 may find a predefined facial expression stored in facial expression database 204A that can be associated with the face captured in the image. After finding a representative predefined facial expression, processor(s) 202 may determine an emotion associated with the predefined facial expression.

In some embodiments, processor(s) 202 may also generate text data representing the audio data. For example, processor(s) 202 may generate text data by performing speech-to-text functionality on the audio data. In some embodiments, processor(s) 202 may duplicate the audio data. Once the audio data is duplicated, processor(s) 202 may generate text data by performing speech-to-text functionality on the duplicate audio data.

After determining an emotion associated with the user, processor(s) 202 may alter the text data. For example, if the user is bored while saying “Great!” processor(s) 202 may add a bored emoji at the end of “Great!” Once the text has been altered, in some embodiments, communications circuitry 206 of electronic device 100 may transmit the altered text to a second electronic device.

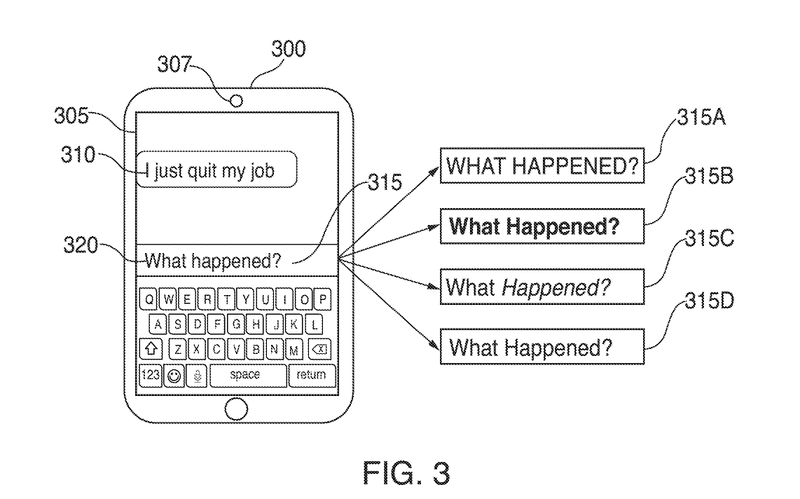

FIG. 3 is an illustrative diagram of exemplary alterations to a message in accordance with various embodiments. As shown in FIG. 3, electronic device 300 may have display screen 305 and camera 307. Electronic device 300 may be similar to electronic device 100 described above in connection with FIGS. 1A, 1B, 1C and 2, the descriptions applying herein. Display screen 305 may be similar to display screen 105 described above in connection with FIGS. 1A, 1B, 1C and display screen 212 described above in connection with FIG. 2, both descriptions applying herein. Camera 307 may be similar to camera 107 described above in connection with FIGS. 1A, 1B, and 1C, and camera(s) 214 described above in connection with FIG. 2, the descriptions applying herein.

In some embodiments, incoming message 310 may be displayed on display screen 305. Incoming message 310 may be similar to incoming message 110 described above in connection with FIGS. 1A, 1B, and 1C, the description applying herein. In response to incoming message 310, a user may prepare outgoing message 315 with text 320. For example, in response to receiving the message “I just quit my job” a user may prepare outgoing message 315 that includes text 320 stating “What happened?” Outgoing message 315 may be an electronic message similar to outgoing message 315 described above in connection with FIGS. 1A, 1B, and 1C, the descriptions applying herein. In some embodiments, when a user prepares outgoing message 315, camera 307 may capture an image of the user. The image captured by camera 307, may depict the user's emotion while entering text 320 of outgoing message 315. In some embodiments, camera 307 may capture multiple images. For example, camera 307 may capture a first image as the user is typing “What” and a second image as the user is typing “happened?”

After being captured, electronic device 300 may analyze the image to determine the emotion of the user. In some embodiments, electronic device 300 may analyze the image using one or more processers. One or more processors, as described herein, may be similar to processor(s) 202 described above in connection with FIG. 2, and the same description applies herein. In some embodiments, electronic device 300 may analyze the captured image by comparing the image to a plurality of predefined facial expressions. In some embodiments, electronic device 300 may store predefined facial expressions in a facial expression database. A facial expression database, as used herein, may be similar to facial expression database 204A described above in connection with FIG. 2, and the same description applies herein. Once a predefined facial expression that can be associated with the face captured in the image is located, electronic device 300 may determine an emotion associated with the predefined facial expression. A more detailed description of the analysis of a captured image, is located above in connection with FIG. 1B and below at step 410 in connection with FIG. 4, both descriptions applying herein. After determining an emotion associated with the user, electronic device 300 may alter outgoing message 315. In some embodiments, electronic device 300 may have one or more processors that may alter outgoing message 315.

In some embodiments, camera 307 may capture an image while the user is typing “What happened?” The user, in some embodiments, may have their eyes and head turned away, their nose wrinkled, mouth closed, and chin jutting. In some embodiments, electronic device 300 may find a predefined facial expression that is closely associated with the user's face and determine that the user is feeling disgusted while typing the words “What happened?” In response to determining emotions of the user while typing “What happened?” electronic device 300 may alter text 320 of outgoing message 315. Electronic device 300 may determine that the emotion disgusted results in “What happened?” being altered by making “What happened?” all caps. The final alteration, in some embodiments, may look similar to first alteration 315A. First alteration 315A shows the phrase “What happened?” in all caps. In some embodiments, electronic device 300 may make alterations to outgoing message 315 based on a categorization of the emotion. For example, the emotion disgust may fall under a negative category. In some embodiments, a negative category may receive capitalization alterations. In other embodiments, negative category emotions may receive alterations to give context to neutral emotions, such as specific emojis, font types, font colors, memes, GIFs, no alteration, etc.

In some embodiments, the user may have their eyes wide, eyebrows pulled down, lips flat, chin jutting, and a wrinkled forehead. In some embodiments, electronic device 300 may find a predefined facial expression that is closely associated with the user's face and determine that the user is feeling angry while typing the words “What happened?” In response to determining emotions of the user while typing “What happened?” electronic device 300 may alter text 320 of outgoing message 315. Electronic device 300 may determine that the emotion angry results in “What happened?” being altered by making “What happened?” bold. The final alteration, in some embodiments, may look similar to second alteration 315B. Second alteration 315B shows the phrase “What happened?” in bold. In some embodiments, electronic device 300 may make alterations to outgoing message 315 based on a categorization of the emotion. For example, the emotion angry may fall under a negative category. In some embodiments, a negative category may receive bold font alterations. In other embodiments, negative category emotions may receive alterations to give context to neutral emotions, such as specific emojis, font types, font colors, memes, GIFs, no alteration, etc.

In some embodiments, camera 307 may capture multiple images. For example, the first image may be captured while the user is typing “What.” The second image may be captured while the user is typing “happened?” Continuing the example, the first image may show the user with slightly raised eyebrows, lips slightly pressed together, and head slightly pushed forward. In some embodiments, electronic device 300 may find a predefined facial expression that is closely associated with the user's face and determine that the user is feeling interested while typing the word “What.” The second image may show the user with their eyebrows slightly pushed together, a trembling lower lip, chin wrinkled, and head slightly tilted downwards. In some embodiments, electronic device 300 may find a predefined facial expression that is closely associated with the user's face and determine that the user is feeling anxious while typing “happened?”

In response to determining emotions of the user while typing each word, electronic device 300 may alter text 320 of outgoing message 315. For example, electronic device 300 may determine that the emotion interest results in no alterations of “What.” Moreover, electronic device 300 may determine that the emotion anxious results in “happened?” being altered by making “happened?” italics. The final alteration, in some embodiments, may look similar to third alteration 315C. Third alteration 315C shows “What” unchanged, while “happened?” is in italics. In some embodiments, electronic device 300 may make alterations to outgoing message 315 based on a categorization of the emotion. For example, the emotion interest may fall under a neutral category. Electronic device 300, for example, may make certain alterations for neutral category emotions. In some embodiments, neutral category emotions may receive no alterations. In other embodiments, neutral category emotions may receive alterations to give context to neutral emotions, such as specific emojis, font types, font colors, memes, GIFs, etc. Moreover, the emotion anxious may fall under a negative category. In some embodiments, a negative category may receive italics font alterations. In other embodiments, negative category emotions may receive alterations to give context to neutral emotions, such as specific emojis, font types, font colors, memes, GIFs, no alteration, etc.

In some embodiments, camera 307 may capture an image while the user is typing “What happened?” The user, in some embodiments, may have their mouth smiling, wrinkles at the sides of their eyes, slightly raised eyebrows, and a level head. In some embodiments, electronic device 300 may find a predefined facial expression that is closely associated with the user's face and determine that the user is feeling happy while typing the words “What happened?” In response to determining emotions of the user while typing “What happened?” electronic device 300 may alter text 320 of outgoing message 315. Electronic device 300 may determine that the emotion happy results in “What happened?” being altered by making “What happened?” in a happy bubbly font. The final alteration, in some embodiments, may look similar to fourth alteration 315D. Fourth alteration 315D shows the phrase “What happened?” in bold. In some embodiments, electronic device 300 may make alterations to outgoing message 315 based on a categorization of the emotion. For example, the emotion happy may fall under a positive category. In some embodiments, a positive category may receive font type alterations. In other embodiments, positive category emotions may receive alterations to give context to neutral emotions, such as specific emojis, font types, font colors, memes, GIFs, no alteration, etc.

FIG. 4 is an illustrative flowchart of an exemplary process 400 in accordance with various embodiments. Process 400 may, in some embodiments, be implemented in electronic device 100 described in connection with FIGS. 1A, 1B, 1C, and 2, and electronic device 300 described in connection with FIG. 3, the descriptions of which apply herein. In some embodiments, the steps within process 400 may be rearranged or omitted. Process 400, may, in some embodiments, begin at step 402. At step 402 a signal is received at an electronic device. In some embodiments, an electronic device detect that a user is inputting a message. For example, a user may start typing a message on display screen. Display screen, as used in process 400, may be similar to display screen 105 described above in connection with FIGS. 1A and 1C, and display screen 212 described above in connection with FIG. 2, the descriptions of which apply herein. Message as used in process 400, may be similar to incoming message 110 and outgoing message 115 both described in connection with FIGS. 1A and 1B, the descriptions of which apply herein. For example, the message may include text, such as “What is going on?” In response to detecting a user inputting a message, a signal may be received by the electronic device. In some embodiments, the signal may be output by input circuitry of the electronic device and received by a camera of the electronic device. Input circuitry, as used in process 400, may be similar to input circuitry 216 described above in connection with FIG. 2, the same description applying herein. The camera, as used in process 400, may be similar to camera(s) 107 described above in connection with FIGS. 1A and 1C, camera(s) 214 described in connection with FIG. 2, and camera 307 described in connection with FIG. 3, the descriptions of which apply herein.

In some embodiments, the signal may be received in response to an audio input being detected by the electronic device. For example, a user may state “What is going on?” and a microphone of the electronic device may receive that audio input. Microphone, as used in process 400, may be similar to microphone(s) 208 described above in connection with FIG. 2, the same description applying herein. In some embodiments, when an audio input is being received, a signal from input circuitry of the electronic device may be sent to a camera of the electronic device.

Process 400 may continue at step 404. At step 404 a camera of the electronic device is activated. In some embodiments, the camera may be activated in response to a signal being received. As described above in step 402, the signal may be output in response to the electronic device detecting a user typing a message. Similarly, the signal may be output in response to an audio input being detected by the electronic device.

In some embodiments, once the camera is activated, the electronic device may determine whether a face of a user is in the frame of the camera. Face, as used in process 400, may be similar to face 130 described above in connection with FIG. 1B, the description of which applies herein. In some embodiments, the electronic device may use one or more processors to determine whether a face of a user is in the frame. One or more processors, as used in process 400, may be similar to processor(s) 202 described above in connection with FIG. 2, the same description applying herein. If a face is in the frame, process 400 may continue. However, if a face is not in the frame, in some embodiments, process 400 may stop. In some embodiments, there may be cameras on both sides of the electronic device (i.e. a front camera and a back camera). If the front camera is activated by a signal received by the input circuitry, and the electronic device has determined that no face is in frame, in some embodiments, a second signal may be received that activates the back camera. Once active, the electronic device may determine whether a face is in the frame of the back camera. In some embodiments, the electronic device may use one or more processors to determine if a face is in the frame. If a face is in the frame, in some embodiments, process 400 may continue. If no face is in the frame, in some embodiments, process 400 may stop.

Process 400 may continue at step 406. At step 406 a message comprising texted data is received. In some embodiments, the electronic device receives a message from a user. The message may be text data inputted by the user. For example, the user may type the message “What is going on?” In some embodiments, the user may input the message using a display screen with a touch panel that is in communication with input circuitry. In some embodiments, the user may input the message using an external piece of hardware (i.e. a keyboard) that is connected to the electronic device. In some embodiments, the message may be in response to an incoming message from a second electronic device operated by a second user. However, in some embodiments, the message may be the first message in a conversation between two users. In some embodiments, the conversation may be between more than two users. For example, the user may be communicating with more than one user using multimedia messaging service (“MMS”).

Process 400 may continue at step 408. At step 408 an image of a user is captured. In some embodiments the image described in process 400 may be similar to image 145 described above in connection with FIG. 1B, the same description applying herein. In some embodiments, the image is captured by the camera of the electronic device. For example, the camera of the electronic device may capture an image of the face of the user inputting the message. In some embodiments, the image may be captured before the user inputs the text, as the user inputs the text, or after the user inputs the text. For example, the image may be captured before the user types “What is going on?” As another example, the image may be captured as the user types “What is going on?” As yet another example, the image may be captured after the user types “What is going on?” In some embodiments, multiple images may be taken. In some embodiments, multiple images may be captured, a first image before the user inputs the text, a second image as the user inputs the text, and a third image after the user inputs the text. Any number of images may be captured and the example using three images is merely exemplary.

In some embodiments, where multiple words are inputted, the camera may capture images as the user inputs each word. For example, if the user inputs “What is going on?” the camera, in some embodiments, may capture an image of the user's face four times. The first image may be captured when the user inputs “What?” The second image may be captured when the user inputs “is.” The third image may be captured when the user inputs “going.” The fourth image may be captured when the user inputs “on?”

In some embodiments, the entire face of the user is captured by the camera in the image. In some embodiments, only part of the user's face is captured by the camera in the image. For example, the image may only show the user's eyebrows, eyes, forehead, and nose. In another example the image may only show the user's mouth and chin. As another example, the image may only show half of the user's face (i.e. one eye, one eyebrow, etc.).

In some embodiments, once the image has been captured, the electronic device may determine whether a face or part of the user's face is present in the image. In some embodiments, the electronic device may perform this analysis by using one or more processors of the electronic device. If, for example, a face is not present in the image, in some embodiments, the electronic device may capture an additional image. The additional image may be captured in an attempt to capture an image of the user's face. Moreover, in some embodiments, the electronic device may display a notification asking the user to move their face into the frame of the image, allowing the camera to capture the face of the user. This notification may be output using output circuitry of the electronic device. Output circuitry, as used in process 400, may be similar to output circuitry 218 described above in connection with FIG. 2, and the same description applies. The output circuitry use the display screen to display the notification. In some embodiments, the output circuitry may use speakers of the electronic device to output the notification. Speakers, as used herein may be similar to speaker(s) 210 described above in connection with FIG. 2, the same description applying herein. In order to output the notification using speakers, in some embodiments, the electronic device may generate audio data representing the notification text data. To generate audio data, the electronic device may use one or more processors to perform text-to-speech functionality on the text data. In some embodiments, once the audio data is generated, the speakers may output the notification.

Process 400 may continue at step 410. At step 410 the image is analyzed to determine an emotion associated with the user. In some embodiments, the electronic device may analyze the captured image to determine the emotion of the user while the user is preparing to send the message, inputting the message, and/or about to transmit the message. The electronic device may analyze the face of the user by using one or more processors to analyze the captured image. In some embodiments, the electronic device may analyze the user's face by examining emotional channels that may indicate the emotion of the user. Emotional channels may refer to facial features that indicate the emotion of a person. Emotional channels, as used in process 400, may be similar to the emotional channels discussed above in connection with FIG. 1B and the same description applies herein. In some embodiments, the electronic device may analyze the captured image for emotional channels, and determine that the user is smiling when inputting “What is going on?”

After determining the user is smiling, the electronic device, in some embodiments, may compare the determined emotional channel to a list of predefined facial expressions. In some embodiments, the electronic device may simply compare the image to the predefined facial expressions without first determining an emotional channel. In some embodiments, the predefined facial expressions may be stored in a facial expression database. Facial expression database, as used in process 400, may be similar to facial expression database 204A described above in connection with FIG. 2, the same description applying herein. The predefined facial expressions, in some embodiments, may singular emotional channels stored that may point to a specific emotion. In some embodiments, the predefined facial expressions may be stored with metadata that, when associated with a captured image, points to a specific emotion. Emotions may be stored in an emotion database. For example, a smile stored in the facial expression database may be associated with happy in the emotion database. Thus, in some embodiments, if the electronic device determines that the user is smiling when inputting “What is going on?” the electronic device may determine that the predefined facial expression of smiling is associated with the emotion happy. Emotion database, as used in process 400, may be similar to emotion database 204B described above in connection with FIG. 2, and the same description applies herein. In some embodiments, combinations of emotional channels may be stored along with singular emotional channels. For example, frowning may be stored as a predefined facial expression. Additionally, frowning with eyebrows lowered may be stored as a predefined facial expression. Combinations of emotional channels and singular emotional channels, in some embodiments, may be associated with different emotions in the emotion database. For example, the predefined facial expression of only frowning may be associated with sad. However, the predefined facial expression of frowning with eyebrows lowered may be associated with angry.

In some embodiments, the electronic device may analyze the captured image by determining the head orientation of the user. The electronic device may utilize one or more processors of the electronic device to determine the head orientation of the user. For example, the electronic device may determine if the user's head is at an angle, tilted up, tilted down, or turned to the side. The aforementioned head orientations are merely exemplary and the electronic device may analyze the head orientation of the user to determine any pitch, yaw, or roll angles in 3D space in order to assist in or determine a possible emotion of the user. Head orientations, in some embodiments, may indicate the emotion of the user. For example, if the user's head is tilted down or to the side, the electronic device may determine that the user is upset. Moreover, in some embodiments, the electronic device may analyze the user's face to determine the user's intraocular distance. Furthermore, in some embodiments, the electronic device may analyze change in skin to determine the emotion of the user. For example, if a user's face turns red, that feature may indicate the user is angry.

In some embodiments, the electronic device may analyze the user's face by examining facial landmarks or features the face and comparing those features to predefined facial expressions. This analysis may use the relative positions of the eyes, nose, cheekbones, and jaw. Additionally, this analysis may use the relative size of the eyes, nose, cheekbones, and jaw. Moreover, this analysis may use the shape of the eyes, nose, cheekbones, and jaw. Once the relative positions, size, and/or shapes are determined, the electronic device may compare the collected data to a plurality of predefined facial expressions stored in the facial expression database. As with the above embodiment, each predefined facial expression may have metadata that associates the predefined facial expression with an emotion. The emotion may be stored on an emotion database. In some embodiments, combinations of facial landmarks or features may be stored along with singular facial landmarks or features. Moreover, combinations of facial landmarks or features may indicate a different emotion than a singular facial landmark or feature. If there is a match, or a similar predefined facial expression, the electronic device may determine the emotion of the user.

In some embodiments, the captured image may only contain a part of the user's face. For example, the captured image may only show the user's mouth. The electronic device, in some embodiments, may compare the captured image containing parts of the user's face to predefined facial expressions. For example, if the user is frowning, the electronic device may associate the captured image with a predefined facial expression of frowning. This, in some embodiments, may indicate the user is sad. Additionally, for example, the electronic device may compare the facial landmarks and features shown in the image to predefined facial expressions.

In some embodiments multiple emotions can be determined by the electronic device. For example, if a user is typing multiple words, the camera may capture multiple images of the user. Each image may be captured as each word is being typed. For example, if a user types the following message “What is going on?” 4 photos may be captured for the 4 words. In this example, the electronic device may determine that the user was happy during “What” and excited during “going on?” The electronic device, in some embodiments, may determine that the user was in a neutral mood during “is.”

While the above embodiments demonstrate a different methods of analyzing facial features, any analysis may be used to determine the emotion of the user. Furthermore, in some embodiments, the different methods of analyzing facial features described above may be used together to determine the emotion of the user.

Process 400 may continue at step 412. At step 412, the message is altered based on the emotion. Once an emotion of the user has been determined, the message can be altered to reflect that emotion. Alterations of messages can include, but are not limited to changing the font type, font color, typographical emphasis, capitalization, spacing between letters or words, punctuation. Additionally, alternations, in some embodiments, may include emojis. Alterations, in some embodiments, may also include GIF's, both static and animated. In some embodiments, alterations may also include memes, photos, and videos. In some embodiments, the user may select preferences for alterations. For example, a user may have an image that the user wants to be used in alterations when the user is angry. This image can be an angry photo the user. In this example, the electronic device may add the angry photo of the user when the electronic device determines that the user is angry when typing a message. Alterations, as used in process 400, may be similar to the alterations of messages discussed above in connection with FIGS. 1C, 2, and 3, the descriptions of which apply herein.

Continuing the above example, once an emotion or emotions of the user has been determined, the electronic device may alter the message. Thus, in some embodiments “What” may be altered to reflect the emotion of happy by changing the font to a ‘bubbly happy font.’ Additionally, “going on?” may be altered to reflect the emotion of surprise by capitalizing the words and adding punctuation. Moreover, “is” may remain the same to reflect the neutral emotion. Thus, the final altered message may be “What is GOING ON???????”

The alteration, in some embodiments, may be based on an emotion category. In those embodiments, emotions may be stored in categories. For example, every emotion may be put into three categories—positive, negative, and neutral. Positive may include happy, excited, and relieved. Negative may include angry, unhappy, and shame. Neutral may include focused, interested, and bored. In some embodiments, the electronic device may have alterations associated with each category. For example, positive emotions may cause the electronic device to the message by changing the font to a ‘bubbly happy font’ and adding a smiley emoji. Negative emotions may cause the electronic device to alter the message by making the font bold and changing the font color red. Neutral emotions may cause the electronic device to not alter the message. In some embodiments, a user may select specific alterations for each category. Three categories for emotions are merely exemplary and any amount of categories may be used.

In some embodiments, once the message is altered based on the emotion, the message may be transmitted to a second electronic device. The electronic device may transmit the message using communications circuitry of the electronic device. Communications circuitry, as used in process 400, may be similar to communications circuitry 206 described above in connection with FIG. 2, the same description applies. In some embodiments, the electronic device may transmit the message automatically once the message is altered. However, in some embodiments, the electronic device may only transmit the message when a user input is received. For example, the user may need to press “SEND” in order to send the message.

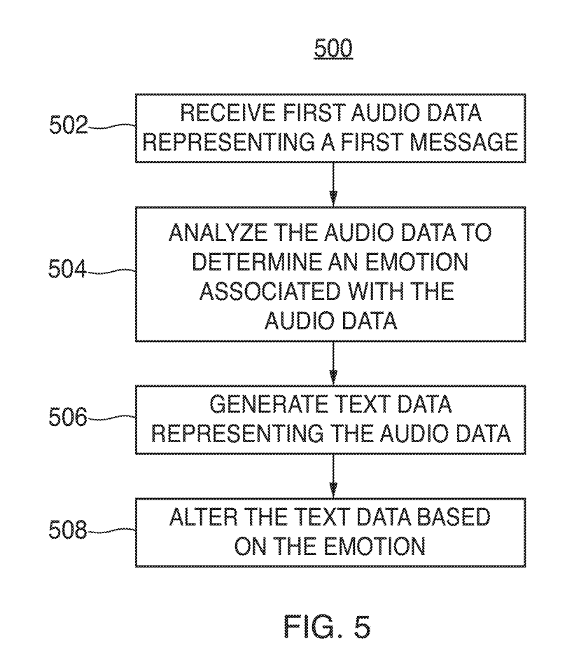

FIG. 5 is an illustrative flowchart of an exemplary process 500 in accordance with various embodiments. Process 500 may, in some embodiments, be implemented in electronic device 100 described in connection with FIGS. 1A, 1B, 1C, and 2, and electronic device 300 described in connection with FIG. 3, the descriptions of which apply herein. In some embodiments, the steps within process 500 may be rearranged or omitted. Process 500, may, in some embodiments, begin at step 502. At step 502 an electronic device receives first audio data representing a first message. In some embodiments, electronic device may receive the audio data by using a microphone of the electronic device. Microphone, as used in process 500, may be similar to microphone(s) 208 described above in connection with FIG. 2, the description applying herein. For example, the user may say “Hello.”

In some embodiments, a camera of the electronic device may receive a signal in response to an audio input being detected. This may be similar to steps 402 described above in connection with process 400 of FIG. 4, the description of which applies herein. The camera, described in process 500, may be similar to camera(s) 107 described above in connection with FIGS. 1A and 1C, camera(s) 214 described in connection with FIG. 2, and camera 307 described in connection with FIG. 3, the descriptions of which apply herein. After a signal is received the electronic device may conduct steps 404, 408, 410, and 412 described above in connection with process 400 of FIG. 4, the descriptions of which apply herein.

Process 500 may continue at step 504. At step 504 the electronic device analyzes the audio data to determine an emotion associated with the audio data. In some embodiments, after the electronic device receives the audio data, the electronic device may analyze the audio data to determine an emotion associated with the user. The electronic device may analyze the audio using one or more processors of the electronic device. One or more processors, as described in process 500, may be similar to processor(s) 202 described above in connection with FIG. 2, the same description applying herein.

In some embodiments the electronic device may analyze the audio data based on the volume. For example, if a user shouts “Hello!” the electronic device may determine that the user is excited. In some embodiments, the electronic device may analyze the audio data based on the pace of the audio data. For example, if a user slowly says “Hello!” (i.e. “Helllllloooooo!”), the electronic device may determine that the user is bored. In some embodiments, the electronic device may determine the audio data based on the pitch and/or frequency of the audio data. For example, if a user says “Hello!” in a high pitch, the electronic device may determine that the user is annoyed. While only three types of analysis of audio are shown, any number of types of audio analysis may be conducted to determine the emotion of the user. Furthermore, the electronic device may combine the means of analysis. For example, the electronic device may analyze the audio data based on volume and pace. Additionally, the electronic device may analyze the audio data based on volume, pace, pitch and frequency.

Process 500 may continue at step 506. At step 506 the electronic device generates text data representing the audio data. In some embodiments, the electronic device may generate text data representing the audio data by converting the audio data to text data. The electronic device, in some embodiments may generate text data by performing speech-to-text functionality on the audio data. Any speech-to-text functionality may be used to generate text data representing the audio data. One or more processors, in some embodiments, may be used to generate text data. For example, processors may convert audio data “Hello!” into text data “Hello!” This text data may represent the audio data. In some embodiments, the electronic device may duplicate the audio data. One or more processors may be used to duplicate the audio data. Once the audio data is duplicated, the electronic device may generate text data by performing speech-to-text functionality on the duplicate audio data. In some embodiments, the original audio data is saved in memory, allowing a user to access the original audio data. Memory, as used in process 500, may be similar to memory/storage 204 described above in connection with FIG. 2, and the same description applies.

Process 500 may continue at step 508. At step 508, the electronic device alters the text data based on the emotion. Once an emotion of the user has been determined, the text data can be altered to reflect that emotion. Alterations of text data can include, but are not limited to changing the font type, font color, typographical emphasis, capitalization, spacing between letters or words, punctuation. Additionally, alternations, in some embodiments, may include emoj is. Alterations, in some embodiments, may also include GIF's, both static and animated. In some embodiments, alterations may also include memes, photos, and videos. In some embodiments, the user may select preferences for alterations. For example, a user may have an image that the user wants to be used in alterations when the user is happy. This image can be a happy photo the user. In this example, the electronic device may add the happy photo of the user when the electronic device determines that the user is happy when typing a message. Alterations, as used in process 500, may be similar to the alterations of messages discussed above in connection with FIGS. 1C, 2, and 3, the descriptions of which apply herein.

The alteration, in some embodiments, may be based on an emotion category. In those embodiments, emotions may be stored in categories. For example, every emotion may be put into three categories-positive, negative, and neutral. Positive may include happy, excited, and relieved. Negative may include angry, unhappy, and shame. Neutral may include focused, interested, and bored. In some embodiments, the electronic device may have alterations associated with each category. For example, positive emotions may cause the electronic device to the message by changing the font to a ‘bubbly happy font’ and adding a smiley emoji. Negative emotions may cause the electronic device to alter the message by making the font bold and changing the font color red. Neutral emotions may cause the electronic device to not alter the message. In some embodiments, a user may select specific alterations for each category. Three categories for emotions are merely exemplary and any amount of categories may be used.

In some embodiments, once the message is altered based on the emotion, the text data may be transmitted to a second electronic device. The electronic device may transmit the text data using communications circuitry of the electronic device. Communications circuitry, as used in process 500, may be similar to communications circuitry 206 described above in connection with FIG. 2, the same description applies. In some embodiments, the electronic device may transmit the text data automatically once the message is altered. However, in some embodiments, the electronic device may only transmit the text data when a user input is received. For example, the user may need to press “SEND” in order to send the message.

The various embodiments of the invention may be implemented by software, but may also be implemented in hardware, or in a combination of hardware and software. The invention may also be embodied as computer readable code on a computer readable medium. The computer readable medium may be any data storage device that may thereafter be read by a computer system.

The above-described embodiments of the invention are presented for purposes of illustration and are not intended to be limiting. Although the subject matter has been described in language specific to structural feature, it is also understood that the subject matter defined in the appended claims is not necessarily limited to the specific features described. Rather, the specific features are disclosed as illustrative forms of implementing the claims.

What is claimed is:

1. A method for facilitating the enhancement of text inputs, the method comprising:
receiving, at a first electronic device, a first signal indicating a first user is inputting a first message;
activating, in response to receiving the first signal, a first camera of the first electronic device;
receiving the first message comprising first text data;
capturing, using the first camera, a first image comprising at least part of the first user's face;
analyzing the first image, analyzing comprising:
comparing the first image to a plurality of predefined facial expressions;
selecting a first predefined facial expression based on one or more features on the first user's face; and
determining a first emotion based on the first predefined facial expression; and
altering the first message based on the determined first emotion.

2. The method of claim 1, altering the first message further comprising:
selecting a small digital image, the small digital image is based on the first emotion; and
generating a second message, the second message comprising the first message and the small digital image.

3. The method of claim 1, further comprising determining, prior to altering the first message, a first category of emotion associated with the first emotion, the first category being one of positive, negative, and neutral.

4. The method of claim 1, altering the first message further comprising:
determining, based on the first emotion, a text display change, the text display change including at least one of:
font type;
font color;
a typographical emphasis;
capitalization; and
spacing between words; and
generating a second message comprising second text data, the second text data being based on the first text data and the text display change.

5. The method of claim 1, the first message being received as the first camera captures the first image.

6. The method of claim 5, the first text data comprising a first word and a second word.

7. The method of claim 6, further comprising:
capturing, as the second word is received, a second image, the second image comprising the at least part of the first user's face;
analyzing the second image, analyzing comprising:
comparing the second image to the plurality of predefined facial expressions;
selecting a second predefined facial expression based on one or more features of the first user's face;
determining a second emotion based on the first predefined facial expression;
altering the first word based on the determined first emotion; and
altering the second word based on the determined second emotion.

8. The method of claim 1 the first message being inputted into the first electronic device using at least one of real-time text and simple message system text.

9. The method of claim 1, further comprising:
transmitting the alerted first message to a second electronic device of a second user.

10. A method for facilitating the enhancement of audio inputs, the method comprising:
receiving, at a first electronic device, first audio data representing a first message of a first user;
analyzing the first audio data to determine a first emotion based on at least one of the following:
a volume of the first audio data;
a pace of the first audio data; and
a pitch of the first audio data;
generating, based on the first audio data, first text data representing the first message and
altering the first text data based on the first emotion.

11. The method of claim 10, further comprising:
receiving a first signal indicating the first user is inputting a message;
activating, in response to receiving the first signal, a first camera of the first electronic device;
capturing, using the first camera, a first image comprising at least part of the first user's face;
analyzing the first image, analyzing comprising:
comparing the first image to a plurality of predefined facial expressions;
selecting a first predefined facial expression based on one or more features of the first user's face; and
determining a second emotion based on the first predefined facial expression; and
altering the first text data based on the determined second emotion.

12. The method of claim 10, altering the first text data further comprising:
selecting a small digital image, the small digital image being based on the first emotion; and
generating a second message, the second message comprising the first text data and the small digital image.

13. The method of claim 10, further comprising determining, prior to altering the first text data, a first category of emotion associated with the first emotion, the first category being one of positive, negative, and neutral.

14. The method of claim 10, altering the first text data further comprising:
determining, based on the first emotion, a text display change, the text display change including at least one of:
font type;
font color;
a typographical emphasis;
capitalization; and
spacing between words; and
generating a second message comprising second text data, the second text data being based on the first text data and the text display change.

15. The method of claim 10, further comprising:
transmitting the alerted first text data to a second electronic device of a second user.

16. An electronic device for facilitating the enhancement of messages, the electronic device comprising:
input circuitry operable to:
receive first text data; and
output a signal in response to receiving the first text data;
a camera operable to:
activate in response to receiving the signal; and
capture a first image, the first image comprising at least part of a first user's face;
memory operable to:
store a plurality of predefined facial expressions; and
store a plurality of emotions associated with the plurality of predefined facial expressions; and
a processor operable to:
analyze the first image captured by the camera, analyze comprising:
compare the first image to a plurality of predefined facial expressions;
select a first predefined facial expression of the plurality of predefined facial expressions based on one or more features on the first user's face; and
determining a first emotion based on the first predefined facial expression; and
alter the first text data based on the first emotion.

17. The electronic device of claim 16, the camera further operable to capture the first image while the input circuitry is receiving the first text data.

18. The electronic device of claim 16, the first electronic device further comprising a microphone operable to receive audio input.

19. The electronic device of claim 18, the processor further operable to generate text data based on the received audio input.

20. The electronic device of claim 16 further comprising communications circuitry operable to transmit the first text data to a second electronic device.
